(19) United States
(12) Patent Application Publication
(10) Pub. No.: US 2007/0129924 A1
(43) Pub. Date: Jun. 7, 2007

(54) Partitioning of tasks for execution by a VLIW hardware acceleration system

(76) Inventors: Henry T. Verheyen, San Jose, CA (US); William Watt, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/296,007

(22) Filed: Dec. 6, 2005

(51) Int. Cl. G06F 17/50

(52) U.S. Cl. 703/14

(57) ABSTRACT

In one aspect, logic simulation of a design of a semiconductor chip is performed on a domain-by-domain basis (e.g., by clock domain), but storing a history of the state space of the domain during simulation. In this way, additional information beyond just the end result can be reviewed in order to debug or otherwise analyze the design.

### BACKGROUND OF THE INVENTION

1. Field of the Invention

The present invention relates generally to VLIW (very long instruction word) processors, including for example simulation processors that may be used in hardware acceleration systems for simulation of the design of semiconductor integrated circuits, also known as semiconductor chips.

2. Description of the Related Art

Simulation of the design of a semiconductor chip typically requires high processing speed and a large number of execution steps due to the large amount of logic in the design, the large amount of on-chip and off-chip memory, and the high speed of operation typically present in the designs for modern semiconductor chips. The typical approach for simulation is software-based simulation (i.e., software simulators). In this approach, the logic and memory of a chip (which shall be referred to as user logic and user memory for convenience) are simulated by computer software executing on general purpose hardware. The user logic is simulated by the execution of software instructions that mimic the logic function. The user memory is simulated by allocating main memory in the general purpose hardware and then transferring data back and forth from these memory locations as needed by the simulation. Unfortunately, software simulators typically are very slow. The simulation of a large amount of logic on the chip requires that a large number of operands, results and corresponding software instructions be transferred from main memory to the general purpose processor for execution. The simulation of a large amount of memory on the chip requires a large number of data transfers and corresponding address translations between the address used in the chip description and the corresponding address used in main memory of the general purpose hardware.

Another approach for chip simulation is hardware-based simulation (i.e., hardware emulators). In this approach, user logic and user memory are mapped on a dedicated basis to hardware circuits in the emulator, and the hardware circuits then perform the simulation. User logic is mapped to specific hardware gates in the emulator, and user memory is mapped to specific physical memory in the emulator. Unfortunately, hardware emulators typically require high cost because the number of hardware circuits required in the emulator increases according to the size of the simulated chip design. For example, hardware emulators typically require the same amount of logic as is present on the chip, since the on-chip logic is mapped on a dedicated basis to physical logic in the emulator. If there is a large amount of user logic, then there must be an equally large amount of physical logic in the emulator. Furthermore, user memory must also be mapped onto the emulator, and requires also a dedicated mapping from the user memory to the physical memory in the hardware emulator. Typically, emulator memory is instantiated and partitioned to mimic the user memory. This can be quite inefficient as each memory uses physical address and data ports. Typically, the amount of user logic and user memory that can be mapped depends on emulator architectural features, but both user logic and user memory require physical resources to be included in the emulator and scale upwards with the design size. This drives up the cost of the emulator. It also slows down the performance and complicates the design of the emulator. Emulator memory typically is high-speed but small. A large user memory may have to be split among many emulator memories. This then requires synchronization among the different emulator memories.

Still another approach for logic simulation is hardware-accelerated simulation. Hardware-accelerated simulation typically utilizes a specialized hardware simulation system that includes processor elements configurable to emulate or simulate the logic designs. A compiler is typically provided to convert the logic design (e.g., in the form of a netlist or RTL (Register Transfer Language)) to a program containing instructions which are loaded to the processor elements to simulate the logic design. Hardware-accelerated simulation does not have to scale proportionally to the size of the logic design, because various techniques may be utilized to partition the logic design into smaller portions (or domains) and load these domains to the simulation processor. As a result, hardware-accelerated simulators typically are significantly less expensive than hardware emulators. In addition, hardware-accelerated simulators typically are faster than software simulators due to the hardware acceleration produced by the simulation processor.

However, hardware-accelerated simulators typically require coordination between overall simulation control and the simulation of a specific domain that occurs within the accelerated hardware simulator. For example, if the user design is simulated one domain at a time, some control is required to load the current state of a domain into the hardware simulator, have the hardware simulator perform the simulation of that domain, and then swap out the revised state of the domain (and possibly also additional data such as results or error messages) in exchange for loading the state of the next domain to be simulated. As another example, commands for functions other than simulation may also need to be coordinated with the hardware simulator. Reporting, interrupts and errors, and branching within the simulation are some examples.

These functions preferably are implemented in a resource-efficient manner and with low overhead. For example, swapping state spaces for different domains preferably occurs without unduly delaying the simulation. Therefore, there is a need for an approach to hardware-accelerated functional simulation of chip designs that overcomes some or all of the above drawbacks.

### SUMMARY OF THE INVENTION

In one aspect, the present invention overcomes the limitations of the prior art by performing logic simulation of a chip design on a domain-by-domain basis, but storing a history of the state space of the domain during simulation. In this way, additional information beyond just the end result can be reviewed in order to debug or otherwise analyze the design.

In one approach, logic simulation occurs on a hardware accelerator that includes a VLIW simulation processor and a program memory. The program memory stores instructions for simulating different domains and also stores the state spaces for the domains. The state space for a first domain is loaded from the program memory into a local memory of the simulation processor. The VLIW instructions for simulating the first domain are also loaded from the program memory and executed by the simulation processor, thus simulating the domain. During the logic simulation, the state space changes. The history of the state space is stored by transferring the state spaces for different simulated times from the local memory of the simulation processor to a memory external to the simulation processor. In different embodiments, the state space history can be transferred from the local memory to the program memory, to a separate storage memory, to a main memory of the host computer, or to memory on extension cards. In various embodiments, the state space can be saved at every time step, can be saved periodically and/or can be saved when requested by the user.

In another aspect of the invention, the chip design is divided into different clock domains and simulated on a clock domain by clock domain basis. In one approach, the clock domains are selected for simulation in an order based on the chronological order of the clock edges for the clock domains. The order for simulation may or may not exactly follow the chronological order of the clock edges. For example, if two clock domains are independent of each other, they may be simulated out of order to reduce the amount of state space swapping required.

In one method, the state space of the clock domain currently selected for simulation is loaded into the local memory of the simulation processor. The corresponding instructions are executed on the simulation processor in order to simulate the logic of the selected clock domain. At some point, the state space of the selected clock domain is swapped out from the local memory, for example when a different clock domain is to be loaded in and simulated. These steps are repeated for one clock domain after another until the logic simulation is completed. In a specific implementation, the chip design is divided into a global clock domain and many local clock domains. Local clock domains are dominated by a specific clock and largely do not affect each other. The global clock domain is introduced to account for interaction between local clock domains. Simulating a specific clock domain includes simulating the corresponding local clock domain as well as the global clock domain.

Depending on the hardware accelerator architecture, state space swapping of the clock domains may be initiated by a software driver running on a host computer. If a state space swap is required at every clock tick, the overhead for communication between the software driver and the hardware accelerator (simulation processor) may become unnecessarily large. This can be reduced by reducing the number of state space swaps and/or by initiating state space swaps by the hardware accelerator rather than the software driver. As an example of the former, independent clock domains may be simulated out of order in order to reduce the number of state space swaps. As an example of the latter, the software driver may initiate state space swaps only for some of the more important clocks, with the hardware accelerator initiating state space swaps for the other clocks. In both of these cases, if the state space is retained in local memory for multiple clock ticks, it may be useful to store the intermediate history of the state space before it is overwritten on the next clock tick.

In another aspect of the invention, the program memory is architected to support multi-threading by the VLIW simulation processor. The VLIW simulation processor has many processor units coupled to many memory controllers. The memory controllers access a program memory that is implemented as a number of program memory instances. In one example, each program memory instance includes one or more memory chips. Each memory controller controls a corresponding program memory instance. The program memory is logically organized into memory slices, and each program memory instance represents one of the memory slices. The program memory contains instructions for execution by the processor units and also contains data for use by the processor units.

By dividing the program memory into slices, each of which is accessed by a separate controller, processor clustering and multi-threading can be supported. The processor units can be logically organized into processor clusters, each of which includes one memory controller and accesses one memory slice. If all processor clusters access the same address in program memory, then an entire VLIW word will be accessed. If different processor clusters access different addresses, the processor clusters can operate fairly independently of each other. Thus, multi-threading is supported.

Other aspects of the invention include methods, devices, systems and applications corresponding to the approaches described above. Further aspects of the invention include the VLIW techniques described above but applied to applications other than logic simulation.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram illustrating a hardware-accelerated simulation system.

FIG. 2 is a block diagram illustrating a simulation processor in the hardware-accelerated simulation system.

FIG. 3 is a diagram illustrating simulation of different domains by the simulation processor.

FIG. 4 is a timing diagram showing clock edges for different clock domains.

FIG. 5 is a block diagram illustrating an interface between the simulation processor and the program memory and storage memory.

FIGS. 6A and 6B are block diagrams illustrating a memory architecture for the program memory.

FIG. 7 is a block diagram illustrating processor clustering to support multi-threading.

FIG. 8 is a block diagram of an organization for the program memory.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

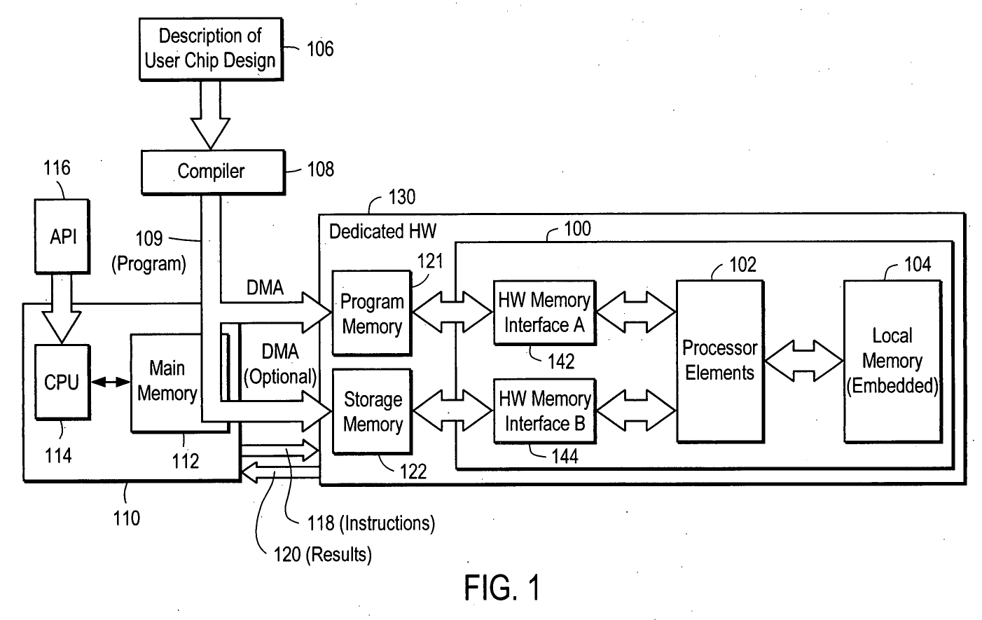

FIG. 1 is a block diagram illustrating a hardware accelerated logic simulation system according to one embodiment of the present invention. The logic simulation system includes a dedicated hardware (HW) simulator 130, a compiler 108, and an API (Application Programming Interface) 116. The host computer 110 includes a CPU 114 and a main memory 112. The API 116 is a software interface by which the host computer 110 controls the hardware simulator 130. The dedicated HW simulator 130 includes a program memory 121, a storage memory 122, and a simulation processor 100 that includes the following: processor elements 102, an embedded local memory 104, a hardware (HW) memory interface A 142, and a hardware (HW) memory interface B 144.

The system shown in FIG. 1 operates as follows. The compiler 108 receives a description 106 of a user chip or design, for example, an RTL (Register Transfer Language) description or a netlist description of the design. The description 106 typically includes descriptions of both logic functions within the chip (i.e., user logic) and on-chip memory (i.e., user memory). The description 106 typically represents the user logic design as a directed graph, where nodes of the graph correspond to hardware blocks in the design, and typically represents the user memory by a behavioral or functional (i.e., non-synthesizable) description (although synthesizable descriptions can also be handled). The compiler 108 compiles the description 106 of the design into a program 109. The program contains instructions that simulate the user logic and that simulate the user memory. The instructions typically map the user logic within design 106 against the processor elements 102 in the simulation processor 100 in order to simulate the function of the user logic. The instructions typically map user memory within design 106 against locations within the storage memory 122. The description 106 received by the compiler 108 typically represents more that just the chip or design itself. It often also represents the test environment used to stimulate the design for simulation purposes (i.e., the test bench). The system can be designed to simulate both the chip design and the test bench (including cases where the test bench requires blocks of user memory).

For further descriptions of example compilers 108, see U.S. Patent Application Publication No. US 2003/0105617 A1, “Hardware Acceleration System for Simulation,” published on Jun. 5, 2003, which is incorporated herein by reference. See especially paragraphs 191-252 and the corresponding figures. The instructions in program 109 are initially stored in memory 112.

The simulation processor 100 includes a plurality of processor elements 102 for simulating the logic gates of the user logic, and a local memory 104 for storing instructions and/or data for the processor elements 102. In one embodiment, the HW simulator 130 is implemented on a generic PCI-board using an FPGA (Field-Programmable Gate Array) with PCI (Peripheral Component Interconnect) and DMA (Direct Memory Access) controllers, so that the HW simulator 130 naturally plugs into any general computing system, host computer 110. The simulation processor 100 forms a portion of the HW simulator 130. The simulation processor 100 has direct access to the main memory 112 of the host computer 110, with its operation being controlled by the host computer 110 via the API 116. The host computer 110 can direct DMA transfers between the main memory 112 and the memories 121, 122 on the HW simulator 130, although the DMA between the main memory 112 and the memory 122 may be optional.

The host computer 110 takes simulation vectors (not shown) specified by the user and the program 109 generated by the compiler 108 as inputs, and generates board-level instructions 118 for the simulation processor 100. The simulation vectors (not shown) include values of the inputs to the netlist 106 that is simulated. The board-level instructions 118 are transferred by DMA from the main memory 112 to the program memory 121 of the HW simulator 130. The storage memory 122 stores user memory data. Simulation vectors (not shown) and results 120 can be stored in either program memory 121 or storage memory 122, for transfer with the host computer 110.

The memory interfaces 142, 144 provide interfaces for the processor elements 102 to access the memories 121, 122, respectively. The processor elements 102 execute the instructions 118 and, at some point, return simulation results 120 to the host computer 110 also by DMA. Intermediate results may remain on-board for use by subsequent instructions. Executing all instructions 118 simulates the entire netlist 106 for one simulation vector.

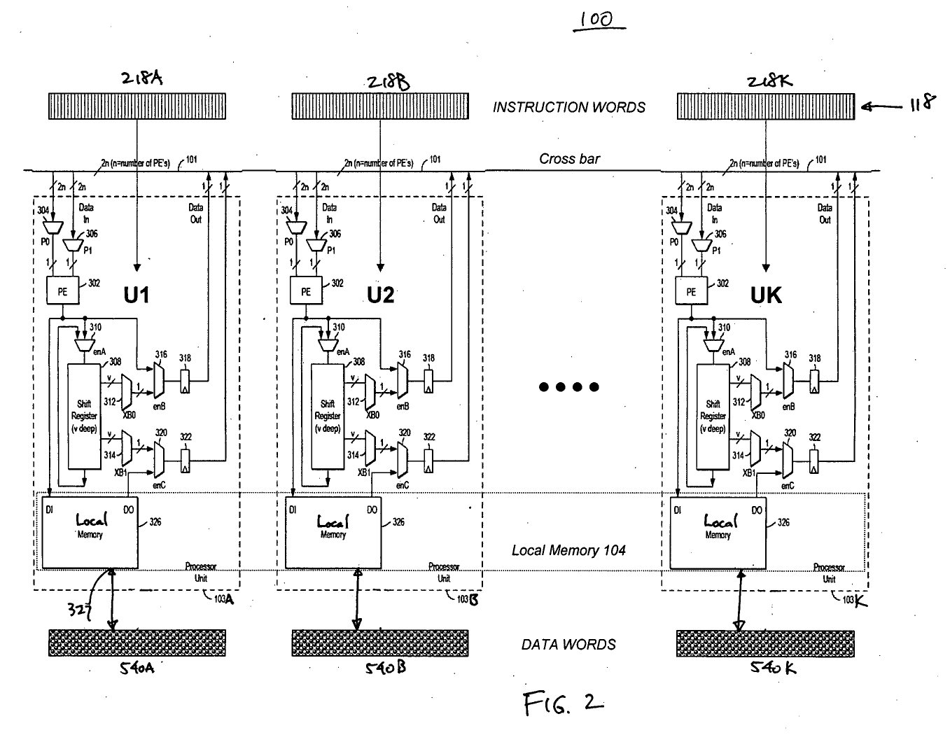

FIG. 2 is a block diagram illustrating the simulation processor 100 in the hardware-accelerated simulation system according to one embodiment of the present invention. The simulation processor 100 includes n processor units 103A-103K (also labeled U1, U2, . . . UK), that communicate with each other through an interconnect system 101. In this example, the interconnect system is a non-blocking crossbar. Each processor unit can take up to two inputs from the crossbar, so for n processor units, 2n input signals are available, allowing the input signals to select from 2n signals (denoted by the inbound arrows with slash). Each processor unit can generate up to two outputs for the crossbar (denoted by the outbound arrows). For n processor units, this produces the 2n output signals. Thus, the crossbar is a 2n (output from the processor units)×2n (inputs to the processor units) crossbar that allows each input of each processor unit 103 to be coupled to any output of any processor unit 103. In this way, an intermediate value calculated by one processor unit can be made available for use as an input for calculation by any other processor unit.

For a simulation processor 100 containing n processor units, each having 2 inputs, 2n signals must be selectable in the crossbar for a non-blocking architecture. If each processor unit is identical, each preferably will supply two variables into the crossbar. This yields a 2n×2n non-blocking crossbar. However, this architecture is not required. Blocking architectures, non-homogenous architectures, optimized architectures (for specific design styles), shared architectures (in which processor units either share the address bits, or share either the input or the output lines into the crossbar) are some examples where an interconnect system 101 other than a non-blocking 2n×2n crossbar may be preferred.

Each of the processor units 103 includes a processor element (PE) 302, a local cache 308 (implemented as a shift register in some implementations), and a corresponding part 326 of the local memory 104 as its dedicated local memory. Each processor unit 103 can be configured to simulate at least one logic gate of the user logic and store intermediate or final simulation values during the simulation. The processor unit 103 also includes multiplexers 304, 306, 310, 312, 314, 316, 320, and flip flops 318, 322. The processor units 103 are controlled by the VLIW instruction 118. In this example, the VLIW instruction 118 contains individual PE instructions 218A-218K, one for each processor unit 103.

The PE 302 is a configurable ALU (Arithmetic Logic Unit) that can be configured to simulate any logic gate with two or fewer inputs (e.g., NOT, AND, NAND, OR, NOR, XOR, constant 1, constant 0, etc.). The type of logic gate that the PE 302 simulates depends upon the PE instruction 218, which programs the PE 302 to simulate a particular type of logic gate.

The multiplexers 304 and 306 select input data from one of the 2n bus lines of the crossbar 101 in response to selection signals in the PE instruction 218. In the example of FIG. 2, each of the multiplexers 304, 306 for every processor unit 103 can select any of the 2n bus lines. If data is being read from the storage memory 122 rather than the crossbar 101, the multiplexers 304, 306 are activated to select the input line coming (either directly or indirectly) from the storage memory 122 (not shown in FIG. 2). In this way, data from the storage memory 122 can be provided to the processor units.

The output of the PE 302 can be routed to the crossbar 101 (via multiplexer 316 and flip flop 318), the local cache 308 or the dedicated local memory 326. The local cache 308 is implemented as a shift register and stores intermediate values generated while the PEs 302 in the simulation processor 100 simulate a large number of gates of the logic design 106 in multiple cycles.

On the output side of the local cache 308, the multiplexers 312 and 314 select one of the memory cells of the local cache 308 as specified in the relevant fields of the PE instruction 218. Depending on the state of multiplexers 316 and 320, the selected outputs can be routed to the crossbar 101 for consumption by the data inputs of processor units 103.

The dedicated local memory 326 allows handling of a much larger design than just the local cache 308 can handle. Local memory 326 has an input port DI and an output port DO for storing data to permit the local cache 308 to be spilled over due to its limited size. In other words, the data in the local cache 308 may be loaded from and/or stored into the memory 326. The number of intermediate signal values that may be stored is limited by the total size of the memory 326. Since memories 326 are relative inexpensive and fast, this scheme provides a scalable, fast and inexpensive solution for logic simulation. The memory 326 is addressed by fields in the PE instruction 218.

The input port DI is coupled to receive the output of the PE 302. In a separate data path, values that are transferred to local cache 308 can be subsequently moved to memory 326 by outputting them from the local cache 308 to crossbar 101 and then re-entering them through a PE 302 to the memory 326. The output port DO is coupled to the multiplexer 320 for possible presentation to the crossbar 101.

The dedicated local memory 326 also has a second output port 327, which can access both the storage memory 122 and the program memory 121. This patent application concentrates more on reading and writing data words 540 between port 327 and the program memory 121. For more details on reading and writing data words 540 to the storage memory 122, see for example U.S. patent application Ser. No. ______ [***attorney docket 10656], “Hardware Acceleration System for Simulation of Logic and Memory,” filed Dec. 1, 2005 by Verheyen and Watt, which is incorporated herein by reference.

For further details and example of various aspects of processor unit 103, see for example U.S. patent application Ser. No. 11/238,505, “Hardware Acceleration System for Logic Simulation Using Shift Register as Local Cache,” filed Sep. 28, 2005; U.S. patent application Ser. No. ______ [***attorney docket 10769], “Hardware Acceleration System for Logic Simulation Using Shift Register as Local Cache with Path for Bypassing Shift Register,” filed Nov. 30, 2005; U.S. patent application Ser. No. ______ [***attorney docket 10656], “Hardware Acceleration System for Simulation of Logic and Memory,” filed Dec. 1, 2005; and U.S. Provisional Patent Application Ser. No. 60/732,078, “VLIW Acceleration System Using Multi-State Logic,” filed Oct. 31, 2005. The teachings of all of the foregoing are incorporated herein by reference.

A simulator can be event-driven or cycle-based. An event-driven simulator evaluates a logic gate (or a block of statements) whenever the state of the simulation changes in a way that could affect the evaluation of the logic gate, for example if an input to the logic gate changes value or if a variable which otherwise affects the logic gate (e.g., tri-state enable) changes value. This change in value is called an event. A cycle-based simulator partitions a circuit according to clock domains and evaluates the subcircuit in a clock domain once at each triggering edge of the clock. Therefore, event count affects the speed at which a simulator runs. A circuit with low event counts runs faster on event-driven simulators, whereas a circuit with high event counts runs faster on cycle-based simulators. In practice, most circuits have enough event counts that cycle-based simulators outperform their event-driven counterparts. The following description first explains how the current architecture can be used to map a cycle-based simulator and then explains how to implement control flow to handle event-driven simulators.

Typically, a software simulator running on the host CPU 114 controls which portions of the logic circuit are simulated by the hardware accelerator 130. The logic that is mapped onto the hardware accelerator 130 can be viewed as a black box in the software simulator. The connectivity to the logic mapped onto the hardware accelerator can be modeled through input and output signals connecting through this black box. This is modeled similarly for both internal and external signals, i.e. all internal signals (e.g. “probes”) are also brought out as input and output signals for the black box. For convenience, these signals will be referred to as the primary input (PI) and primary output (PO) for the black box. Note that this can be a superset of the primary input and primary output of a specific chip design if the black box represents the entire chip design. Usually, system task and other logic (e.g. assertions) are also included, and often, a part of the test bench is also included in the black box.

When any of the primary input signals changes in the software simulator, this causes an event that directly affects the black box. The software simulator sends the stimulus to the black box interface, which in this example is a software driver. The driver can send this event directly to the hardware accelerator, or accrue the stimulus. Accrual occurs when the hardware accelerator operates on a cycle-based principle. For synchronous clock domains, only events on clock signals require the hardware accelerator to compute the PO values. However, for combinational paths throughout the design, any event on an input typically will require the hardware accelerator to compute PO values. The software driver in this case updates the PI changes and logs which clock signals have events. At the end of evaluation of the current time step, before the simulator moves to the next time step, the software driver is called again, but now to compute the PO values for the black box. This will be referred to as a simulation event. Note that there will typically be only one simulation event per time-point, although it is possible for the software simulator to re-evaluate the black box if combinatorial feedback paths exist. At this point, the software driver is analyzing the list of the clock signals that have changed, and it directs the hardware accelerator to compute the new PO values for those domains. Other domains, for which the clocks did not change, typically need not be updated. This leads to better efficiency. To support combinational logic as well as clock domain interaction, a combinational clock domain is introduced which is evaluated regardless of clock events.

At each simulation event, the accrued changes are copied from main memory 112 into program memory 121, using DMA methods. After the DMA completes, a list of which clock domains and the sequence in which to execute them resides in the software driver. This list can be used to invoke the hardware accelerator 130 to update the POs for each clock domain, one domain at a time, or this list can be sent to the hardware accelerator in its entirety and have the hardware control routine execute the selected clock domains all at once, in a given sequence. Combinations hereof are also possible.

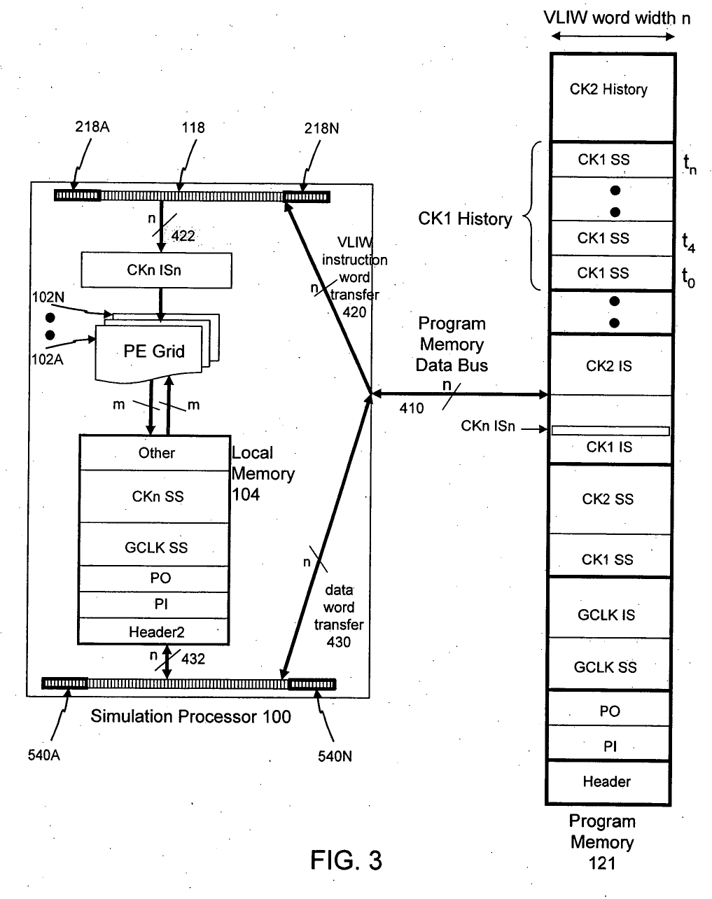

In one embodiment, the program memory 121 is arranged as depicted in FIG. 3. FIG. 3 is a diagram illustrating a memory arrangement of different domains by the simulation processor 100, according to one embodiment of the present invention. As mentioned above, executing all instructions 118 simulates the entire netlist 106 for one simulation vector. However, the entire netlist 106 typically is not loaded into local memory 104 and simulated all at once. Instead, the simulation typically is partitioned into different domains. Domains are then loaded into local memory 104 in sequence, and the entire netlist is simulated on a piecewise basis, one domain at a time.

FIG. 3 shows an example where the chip design is partitioned into clock domains, and the simulation is executed on a cycle-basis, one clock domain at a time. A single chip may use many clocks: clocks received from external sources, internally generated clocks and/or local clocks derived from any of these. Circuits in a chip design are in the same clock domain if events in the circuit are determined by the same clock. Inputs to a clock domain are synchronized to the clock for that domain, but can be sourced from other domains, as is common in gated clock domains. In the example of FIG. 3, the chip design is divided into a number of “local” clock domains, denoted by CK1, CK2, etc., and a global domain denoted by GCLK. The local clock domains are portions of the chip design that are evaluated upon a simulation event, or clock edge for that clock domain. The CK1 domain is timed by CK1 and the simulation of the circuits in the CK1 domain pertain to logic that depends only on clock CK1. Hence, these domains are “local.” The global domain GCLK contains portions of the chip design that overlap more than one clock domain, for example circuitry where timing is transitioned from one clock to a different clock, or a combinational path from primary inputs to primary outputs of a design, for example an asynchronous reset signal. The simulation of the circuitry affected by CK1 typically requires the simulation of the CK1 domain and the GCLK domain. For CK2, simulation of the CK2 domain and the GCLK domain typically is required, and so on. If CK2 was a gated clock domain of CK1, then CK2 would need to be evaluated whenever clock CK1 has an event and the gate logic enables CK2 causing CK2 therefore to also have an event. If CK1 and CK2 are asynchronous domains, they each would be evaluated when their events occur. The global GCLK domain is evaluated upon every event.

For instance, if CK1 and CK2 are asychnronous clocks, operating at CK1=250 Mhz (4.0 ns) and CK2=330 MHz (3.3 ns), respectively, events would occur at t=3.3 ns (first clock edge on CK1), t=4.0 ns (first clock edge on CK2), t=6.6 ns (2^{nd} clock edge for CK1), t=8.0 ns (2^{nd} clock edge for CK2), and so on. At each of these events, the GCLK domain is also evaluated.

As a different example, assume that CK1 and CK2 are synchronous clocks, e.g. CLK2 is the gated divide-by-two (half-frequency) clock of CK1. Assume CK2=125 MHz and CK1=250 MHz. Then, events would occur at t=4.0 ns for CK1 and GCLK, at t=8.0 ns for CK1, CK2 and GCLK, at t=12.0 ns for CK1 and GCLK, at t=16.0 ns for CK1, CK2 and GCLK and so on.

Information about the different domains is stored in the program memory 121. Each domain has an instruction set (IS) and a state space (SS). The instruction set is the group of instructions 118 used to simulate that domain. The state space is the current state of the variables in that clock domain. For convenience, the states spaces for the local domains CK1 SS, CK2 SS, etc. are stored together, as shown in FIG. 3. Similarly, the instruction sets for the local domains CK1 IS, CK2 IS, etc. are also stored together. The IS sets are instructions for each domain and they typically do not change during execution. Only one IS set is typically required for each SS, although multiple sets may be stored and selected by the hardware control routine. For instance, one SS may be accessed by several IS sets for clock evaluation, primary output evaluation, asynchronous set evaluation, asynchronous reset evaluation, assertion evaluation, or test code evaluation. The SS sets are data for each domain and they typically change each time the domain is evaluated. The SS sets are stored separately from the IS sets as there can be multiple instances of the SS sets, one for each time step in the simulation for that domain, allowing a history to be stored. In this example, the program memory 121 also includes the primary input (PI), primary output (PO) and a header. The primary input includes the stimulus vector. The primary output includes the response to the stimulus vector. The header can be further subdivided into separate headers that apply to each domain, and a global header that applies to the memory arrangement.

During simulation of a specific clock domain, the state space for the clock domain is stored in local memory 104 and the instructions 118 simulating the clock domain are fetched and executed. As shown in FIG. 3, the local memory 104 typically includes the state space of the local clock domain being simulated (CKn SS) and the state space of the global clock domain (GCLK SS). The local memory 104 may also contain PO, PI, (optionally) a header, and additional data such as temporary variables or local memory allocated for the simulation of user memory in the chip design.

During simulation, the instructions used to simulate the clock domain CKn (including the instructions for global clock domain GCLK) are fetched and executed by the PEs 102. FIG. 3 shows the fetch 410-420-422 of instruction CKn ISn from program memory 121 to the PEs 102. Execution of the instructions changes the state space. Once all instructions 118 for the clock domain have been executed, simulation of the clock domain for that time step is complete and the revised state space CKn SS is stored 432-430-410 back to program memory 121. The state space for the next clock domain to be simulated is loaded 410-430-432 into local memory 104 in preparation for simulation. This process repeats until simulation of the chip is completed.

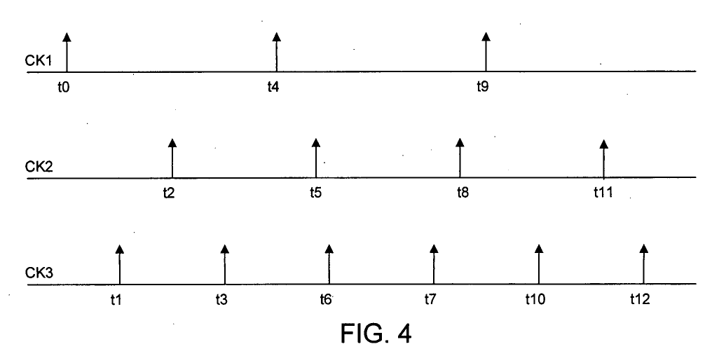

The same clock domain usually will be loaded into local memory 104 more than once to simulate different time steps. FIG. 4 is a timing diagram showing clock edges for three different clocks CK1-CK3. It is assumed that at this edge, a calculation for the logic simulation is required. Depending on the logic behavior, only positive edges, negative edges or both edges will be simulated. FIG. 4 shows only the edges that need to be simulated. The edges are labeled t0-t14 in chronological order: t0 occurs before t1, which is before t2, etc. The times t0, t1, etc. are simulated times That is, these would be actual times for execution if the chip being simulated were built and operating. However, they are not the actual times for simulation. The actual time required to simulate a clock domain typically will be longer than the time steps t0, t1, etc. For example, if CK1 is a 500 MHz clock, the time between CK1 clock edges (from t0 to t4) would be 2 ns. However, the simulation of the chip from time t0 to time t4 will take longer than 2 ns.

In a straightforward implementation, at time step t0 of the simulation, clock domain CK1 is simulated. The state space for CK1 is loaded into local memory 104 and the instruction set for CK1 (and GCLK) is executed. At time step t1 of the simulation, the state space for CK1 is stored back to the program memory 121 and the state space for clock domain CK3 is loaded into local memory 104. Once the simulation of CK3 is completed, the next time step t2 in the simulation is taken. Clock domain CK2 is loaded to the local memory 104 and simulated. This continues for all clock edges in the simulation. Note that time steps t6 and t7 are both clock edges for CK3 and there are no intervening clock edges for other clock domains. Hence, clock domain CK3 can be simulated for two consecutive time steps without swapping out the state space.

States spaces that are being swapped out of local memory 104 can be written back to their original memory locations in program memory 121, overwriting the old state space information. This conserves memory but, unless the old state space was preserved somewhere else, the history of the state space will be lost. In one approach, the old state space can be copied from program memory 121 to the host computer's main memory 112 before being overwritten. In an alternate approach, rather than overwriting the old state space, the new state space is written to a different address in program memory 121. In FIG. 3, the portion of program memory 121 labeled CK1 History contains the CK1 state spaces at different time steps. The CK1 state space after time step t0 is written to the location labeled t0. The address pointer is incremented and the CK1 state space after time step t4 is written to the location labeled t4, and so on. In this way, the history of the state space is preserved. This can be done in place of, or in addition to, writing the state space back to a single location (e.g., the area labeled CK1 SS in the bottom half of program memory 121).

In addition, not every time step need be recorded. Only every j^{th} time step or only selected time steps (e.g., specific time steps that are requested by the user) may be recorded instead. Information other than the state space may also be preserved. Data can also be written at times other than as part of a state space swap. In FIG. 4, there is no state space swap between time steps t6 and t7 because both time steps are clock edges for clock domain CK3. However, it may be desirable to preserve the CK3 state space after time step t6. Therefore, the state space can be written to program memory 121 even though there is no state space swap. As a final variation, rather than recording all the values of every variable in the state space at each time step, the state space can be recorded in an incremental format. For example, only the changed variables could be recorded.

FIGS. 3-4 introduced state space swap in a situation where the local clock domains were loaded into local memory 104 one at a time and the clock domains were simulated in the chronological order of the relevant clock edges. Neither of these is required. For example, if all three clock domains can fit into local memory 104, they can be simulated without any state space swapping. Alternately, if two clock domains can fit into local memory 104, the simulation could proceed as follows. For time step t0, CK1 is loaded into local memory 104. At t1, CK3 is loaded into local memory 104, which now contains both CK1 and CK3. At t2, CK2 is needed so CK1 is swapped out for CK2. C1 is swapped out rather than CK3 because CK3 will be needed again at t3, before CK1 is needed. The local memory now contains CK2 and CK3. No swap is needed at t3 since CK3 is already in local memory 104, and so on. Alternatively, the compiler 108 can pack several small SS sets into a single larger SS at compilation time, and then each of the related IS sets would refer to this combined SS, and it would be swapped in (if required) when any of the IS sets was executed.

As another variation, the clock domains can be simulated out of order if there are no dependencies. For example, assume that CK3 does not depend on CK2. The simulation could proceed as follows. First simulate CK1 at time step to, then CK3 at time steps t1 and t3, then CK2 at time step t2, and so on. By simulating CK3 at time steps t1 and t3 consecutively and then simulating CK2 at time step t2, the number of state space swaps is reduced. The out of order simulation can be performed because CK3 does not depend on CK2. Since the simulation of CK2 at t2 does not affect the simulation of CK3 at t3, the order of these simulations can be reversed. Note that if CK2 does not depend on CK3, this does not necessarily mean that CK3 also does not depend on CK2.

One advantage of this out of order execution is that control overhead can be reduced in some architectures. In many cases, the state space swap is initiated by a software driver, which is a software program running on the host computer 110 and typically has access to the DMA interfaces to the hardware simulator 130. In the chronological, edge-by-edge approach, at time t0, the software driver would instruct the simulation processor 100 to load the CK1 state space and simulate CK1. Then at time t1, the driver would instruct the simulation processor to swap out the CK1 state space for the CK3 state space and then simulate CK3, and so on. For each clock edge shown in FIG. 4, there would be a corresponding interaction with the software driver to swap state spaces. This interaction can require unnecessary overhead. By simulating the clock domains out of order, the number of state space swaps is reduced. Therefore, the number of interactions with the software driver and the corresponding overhead are also reduced.

In a related approach, the simulation may be driven only from certain clock edges rather than by all clock edges. For example, if the CK2 and CK3 domains do not depend on each other, then the simulation could be triggered by the CK1 edges. The software driver interacts with the simulation processor 100 only on the CK1 edges (and not on all clock edges). At CK1 clock edge t0, the software driver instructs the simulation processor 100 to simulate one clock tick for CK1, one clock tick for CK2 and two clock ticks for CK3 (i.e., the simulations for clock edges t0-t3). At t4, the software driver instructs the simulation processor 100 to simulate another clock tick for CK1, two clock ticks for CK2 and two clock ticks for CK3, and so on. The clock ticks can be executed in order or, if further optimization is possible, out of order. One advantage is that the overhead for interaction with the software driver is reduced. This example uses only three interactions (at t0, t4 and t9) whereas the edge-by-edge approach would use thirteen interactions (for t0-t12). Saving the state space for every time step (or after certain time steps) is useful in this approach since the simulation processor and software driver do not interact at every time step.

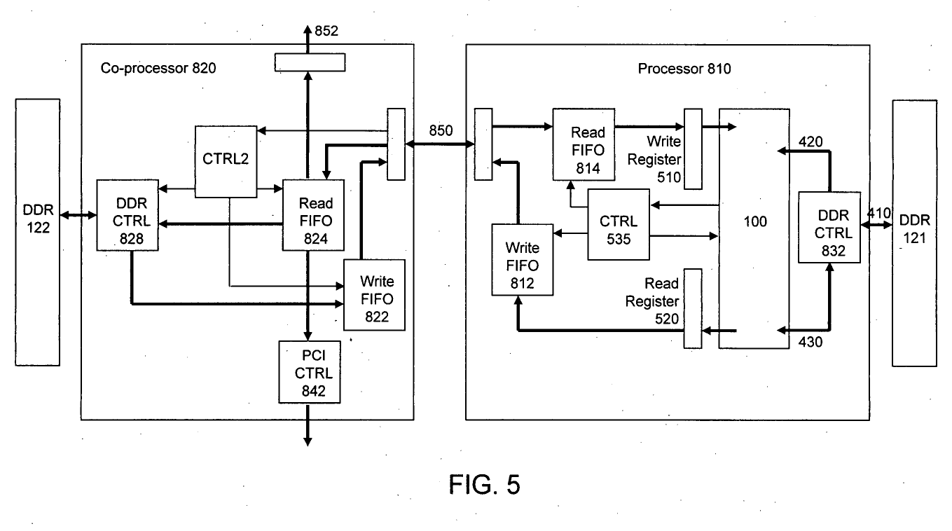

FIG. 5 is a block diagram illustrating an example of the interfaces between the simulation processor 100 and the program memory 121 and storage memory 122. This particular example is divided into a processor 810 and co-processor 820, each with its own read FIFOs, write FIFOs and control. The two parts 810 and 820 communicate to each other via an intermediate interface 850. Although this division is not required, one advantage of this approach is that the design is modularized. For example, additional circuitry on the co-processor 820 can be added to introduce more functionality. The same thing can be done for the processor 810.

The interface in FIG. 5 operates as follows. Instruction fetches from the program memory 121 occur via path 410-832-420 to instruction registers in the simulation processor 100. Data reads from the program memory 121 to the simulation processor 100 (e.g., loading a new state space) occur via path 410-832-430. Data writes from the simulation processor 100 to the program memory 121 (e.g., writing back a revised state space) occur via the reverse path 430-832-410.

Reads and writes from and to the storage memory 122 occur through the processor 810 and co-processor 820. For a write to storage memory, the storage memory address flows from read register 520 to write FIFO 812 to interface 850 to read FIFO 824 to memory controller 828. The data flows along the same path, finally being written to the storage memory 122. For a read from storage memory, the storage memory address flows along the same path as before. However, data from the storage memory 122 flows through memory controller 828 to write FIFO 822 to interface 850 to read FIFO 814 to write register 510 to simulation processor 100.

The operating frequency for executing instructions on the simulation processor 100 and the data transfer frequency (bandwidth) for access to the storage memory 122 generally differ. In practice, the operating frequency for instruction execution is typically limited by the bandwidth to the program memory 121 since instructions are fetched from the program memory 121. The data transfer frequency to/from the storage memory 122 typically is limited by either the bandwidth to the storage memory 122 (e.g., between controller 828 and storage memory 122), the access to the simulation processor 100 (via read register 510 and write register 520) or by the bandwidth across interface 850.

In one implementation designed for logic simulation, the program memory 121 and storage memory 122 have different bandwidths and access methods. The program memory 121 connects directly to the main processor 810 and is realized with a bandwidth of over 200 billion bits per second. Storage memory 122 connects to the co-processor 820 and is realized with a bandwidth of over 20 billion bits per second. As storage memory 122 is not directly connected to the main processor 810, latency (including interface 850) is a factor. In one specific design, program memory 121 is physically realized as a reg [2,560] mem [8M], and storage memory 122 is physically realized as a reg [256] mem [125M] but is further divided by hardware and software logic into a reg [64] mem [500M]. Relatively speaking, program memory 121 is wide (2,560 bits per word) and shallow (8 million words), whereas storage memory 122 is narrow (64 bits per word) and deep (500 million words). This should be taken into account when deciding on which DMA transfer (to either of the program memory 121 and the storage memory 122) to use for which amount and frequency of data transfer. For this reason, the VLIW processor can be operated in co-simulation mode or stimulus mode.

In co-simulation mode, a software simulator is being executed on the host CPU 114, using the main memory 112 for internal variables. When the hardware mapped portion needs to be simulated, the software simulator invokes a request for response data from the hardware mapped portion, based on the current input data (at that time-step). In this mode, the software driver transfers the current input data (single stimulus vector) from the software simulator to the hardware simulator 130 by using DMA into program memory 121. Upon completion of the execution for this input data set, the requested response data (single response vector) is stored in program memory 121. The software driver then uses DMA to retrieve the response data from the program memory 121 and communicate it back to the software simulator. In an alternate approach, state space history and other data is transferred back to the host computer 110 via interface 842 (shown as a PCI interface in this example) and the path 520-812-850-824-842.

In stimulus mode, there is no need for a software simulator being executed on the host CPU 114. Only the software driver is used. In this mode, the hardware accelerator 130 can be viewed as a data-driven machine that prepares stimulus data (DMA from the host computer 110 to the hardware simulator 130), executes (issues start command), and obtains stimulus response (DMA from the hardware simulator 130 to the host computer 110).

The two usage models have different characteristics. In co-simulation with a software simulator, there can be significant overhead observed in the run-time and communication time of the software simulator itself. The software simulator is generating, or reading, the vast amount of stimulus data based on execution in CPU 114. At any one time, the data set to be transferred to the hardware simulator 130 reflects the I/O to the logic portion mapped onto the hardware simulator 130. There typically will be many DMA requests in and out of the hardware simulator 130, but the data sets will typically be small. Therefore, use of program memory 121 is preferred over storage memory 122 for this data communication because the program memory 121 is wide and shallow.

In stimulus mode, the interactions to the software simulator may be non-existent (e.g. software driver only), or may be at a higher level (e.g. protocol boundaries rather than vector/clock boundaries). In this mode, the amount of data being transferred to/from the host computer 110 typically will be much larger. Therefore, storage memory 122 is typically a preferred location for the larger amount of data (e.g. stimulus and response vectors) because it is narrow and deep. Therefore, data, including state space history, can be accumulated in the storage memory 122 rather than (or in addition to) the program memory 121, for later transfer to the host computer 110.

In an expansion mode, interface 852 allows expansion to another card. Data, including state space history, can be transferred to the other card for additional processing or storage. In one implementation, this second card compresses the data. An analogous approach can be used to transfer data from other cards back to the co-processor 820.

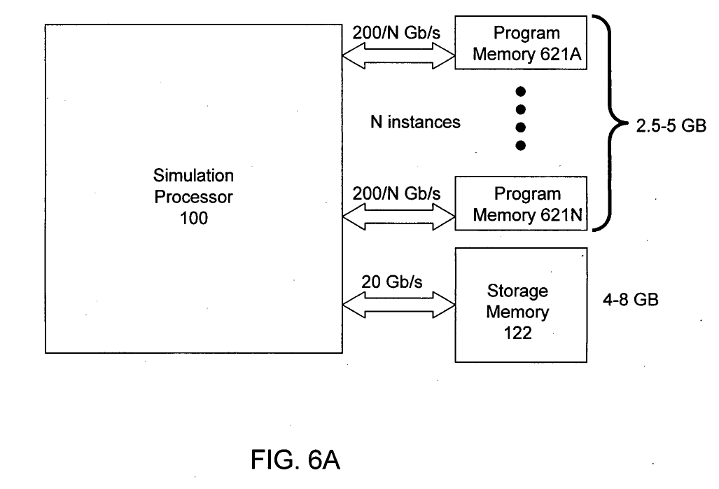

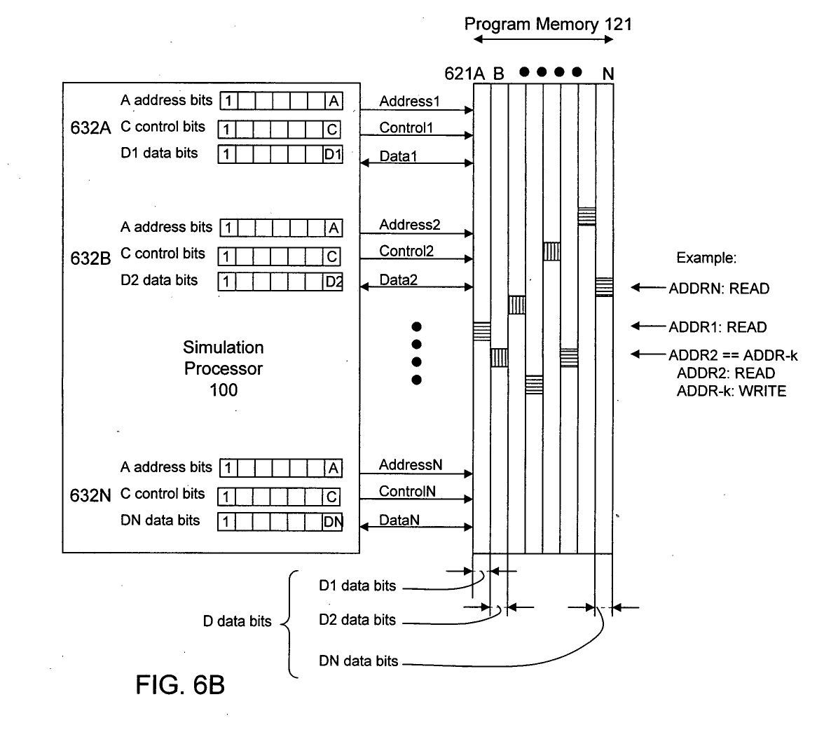

FIGS. 6A and 6B are block diagrams illustrating a memory architecture for the program memory 121. In this example, the program memory 121 is not implemented as a single memory instance. Rather, it is implemented as N separate instances 621A-621N. If the total bandwidth to the program memory 121 is 200 Gb/s, then the memory bandwidth to each memory instance 621 is 200/N Gb/s. In one implementation, each memory instance 621 is a group of memory chips that is controlled by the same controller. Each group of memory chips typically includes between five to seven memory chips due to the required fanout for control signals versus maximum operating frequency for the controller.

Furthermore, as shown in FIG. 6B, the overall program memory 121 is organized into memory slices 621A-621N and each slice implemented by one of the memory instances 621A-621N. Each memory instance 621 (or memory slice) is accessed by a separate memory controller 632A-632N, which are represented in FIG. 6B by address, control and data bits. In the implementation mentioned above, the program memory 121 is physically realized as a reg [2,560] mem [8M]. In other words, the data width of the program memory 121 is D=2560 bits and there are 8M of these 2560-bit words. If there are N memory slices of equal width, then each slice 621A-N contains 8M subwords of width 2560/N. More generally, memory slice 621A is D1 bits wide, slice 621B is D2 bits wide, etc. D1+D2+ . . . +DN=D. In FIG. 6B, memory slice 621A is represented by the leftmost tall, skinny rectangle of the program memory 121. It is accessed by memory controller 632A. Memory slice 621B is represented by the next tall, skinny rectangle, and it is accessed by memory controller 632B, and so on.

With this architecture, each memory slice 621 can be accessed and controlled separately. Controller 610A uses Address 1, Control 1 and Data 1. Control 1 indicates that data should be read from Address 1 within memory slice 621A. Control 2 might indicate that data should be written to Address 2 within memory slice 621B. Control 3 might indicate an instruction fetch (a type of data read) from Address 3 within memory slice 621C, and so on. In this way, each memory slice 621 can operate independently of the others. The memory slices 621 can also operate together. If the address and control for all memory slices 621 are the same, then an entire word of D bits will be written to (or read from) a single address within program memory 121.

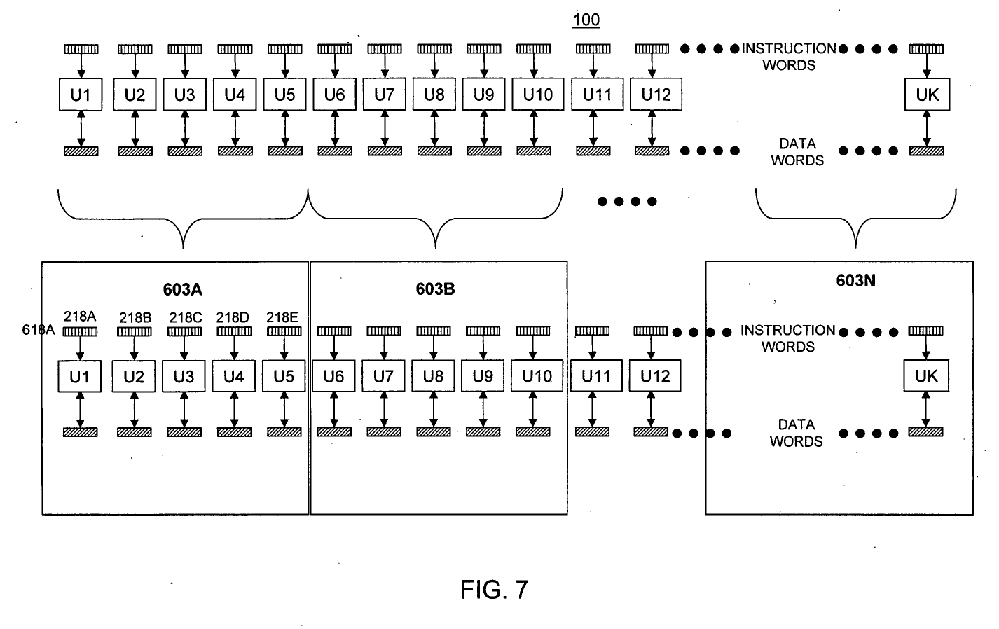

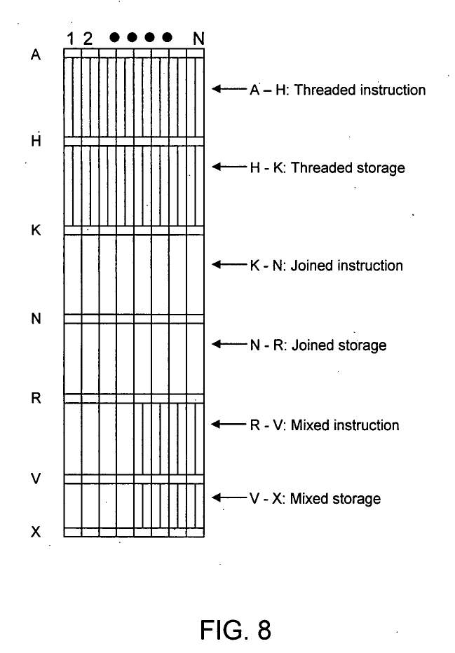

FIGS. 7 and 8 are block diagrams illustrating example organizations of the simulation processor 100 and program memory 121 to take advantage of this flexible capability. In FIG. 7, the simulation processor 100 includes K processor units U1-UK. The processor units are grouped into clusters 603A-603N, corresponding to the memory controllers 632A-632N and memory slices 621A-621N. Processor cluster 603A includes five processor units U1-U5. Each processor unit can execute a PE instruction 218A-218E. The PE instructions 218A-218E together form a cluster instruction 618A, which is D1 bits wide. Cluster instruction 618B is D2 bits wide, cluster instruction 618C is D3 bits wide, etc. All of the cluster instructions 618A-618N together form the VLIW instruction 118, which is D bits wide. Since each processor cluster 603 corresponds to a different memory controller 632, the corresponding cluster instructions 618 can be fetched and executed independently for each cluster 603. Thus, multi-threaded execution can be supported, as shown in FIG. 6B. Other instruction formats are possible. For example, all D1 bits could encode a cluster-level instruction that instructs the cluster as a whole how to behave, rather than encoding five separate PE instructions, each of which is D1/5 bits wide and instructs a single PE how to behave.

Typically, the instruction word width for each processor cluster, e.g. D1, is limited by physical realization, whereas the number of instruction bits per PE and also the number of data bits for storage are determined by architecture choices. As a result, D1 may not correspond exactly to the PE-level instruction width times the number of PEs in the processor cluster. Furthermore, additional bits typically are used to program various cluster-level behavior. If it is assumed that at least one of the PEs is idle in each cluster, then those PE-level instruction bits can be available to program cluster-level behavior. The widths of the cluster-level instructions can be consciously designed to optimize this mapping. As a result, cluster-level instructions for different processor clusters may have different widths.

FIG. 8 shows a memory organization to support multi-threaded execution. Here, program memory addresses A-H are dedicated to threaded instruction. Up to N threads can be active simultaneously. Addresses H-K are dedicated to threaded storage. Up to N independent reads/writes can be supported. Addresses K-N and N-R support joined instruction and storage, respectively. A common address is used to access the entire VLIW word, which is either a full VLIW instruction (addresses K-N) or a full VLIW data word (addresses N-R). Addresses R-V and V-X support mixed instruction and storage, respectively.

Although the present invention has been described above with respect to several embodiments, various modifications can be made within the scope of the present invention. For example, although the present invention is described in the context of PEs that are the same, alternate embodiments can use different types of PEs and different numbers of PEs. The PEs also are not required to have the same connectivity. PEs may also share resources. For example, more than one PE may write to the same shift register and/or local memory. The reverse is also true, a single PE may write to more than one shift register and/or local memory.

In another aspect, the simulation processor 100 of the present invention can be realized in ASIC (Application-Specific Integrated Circuit) or FPGA (Field-Programmable Gate Array) or other types of integrated circuits. It also need not be implemented on a separate circuit board or plugged into the host computer 110. There may be no separate host computer 110. For example, referring to FIG. 1, CPU 114 and simulation processor 100 may be more closely integrated, or perhaps even implemented as a single integrated computing device.

Although the present invention is described in the context of logic simulation for semiconductor chips, the VLIW processor architecture presented here can also be used for other applications. For example, the processor architecture can be extended from single bit, 2-state, logic simulation to 2 bit, 4-state logic simulation, to fixed width computing (e.g., DSP programming), and to floating point computing (e.g. IEEE-754). Applications that have inherent parallelism are good candidates for this processor architecture. In the area of scientific computing, examples include climate modeling, geophysics and seismic analysis for oil and gas exploration, nuclear simulations, computational fluid dynamics, particle physics, financial modeling and materials science, finite element modeling, and computer tomography such as MRI. In the life sciences and biotechnology, computational chemistry and biology, protein folding and simulation of biological systems, DNA sequencing, pharmacogenomics, and in silico drug discovery are some examples. Nanotechnology applications may include molecular modeling and simulation, density functional theory, atom-atom dynamics, and quantum analysis. Examples of digital content creation include animation, compositing and rendering, video processing and editing, and image processing.

As a specific example, if the PEs are capable of integer or floating point arithmetic (as described in U.S. Provisional Patent Application Ser. No. 60/732,078, “VLIW Acceleration System Using Multi-State Logic,” filed Oct. 31, 2005, hereby incorporated by reference in its entirety), the VLIW architecture described above enables a general purpose data driven computer to be created. For example, the stimulus data might be raw data obtained by computer tomography. The hardware accelerator 130 is an integer or floating point accelerator which produces the output data, in this case the 3D images that need to be computed.

Depending on the specifics of the application, the hardware accelerator can be event-driven or cycle-based (or, more generally, domain-based). In the domain-based approach, the problem of computing the required 3D images is subdivided into “subproblems” (e.g., perhaps local FFTs). These “subproblems” are analogous to the clock domains described above, and the techniques described above with respect to clock domains (e.g., state space swap, state space history, out of order execution) can also be applied to this situation. Loops can be implemented by unrolling the loop into a flat, deterministic program. Alternately, loop control can be implemented by the host software, which determines which domains are loaded into the hardware accelerator for evaluation based on the state of the loop. Branching can be implemented similarly. Alternatively, loop control can be implemented by a hardware state machine which loops or branches depending on values in one or more of the SS sets. This can improve performance by reducing the communication back to the host software between loop iterations.

The multi-threading and clustering techniques described in FIGS. 6-8 can also be used in applications other than logic simulation. For example, the PEs can be clustered to perform certain arithmetic tasks. As another example, different threads can be used to evaluate different problem domains simultaneously.

The concepts of co-simulation mode and stimulus mode also apply to applications other than logic simulation. In co-simulation mode for a VLIW math hardware accelerator, host software controls usage of the hardware accelerator. When a specific math function is to be evaluated, the host software invokes a request for the evaluation. The software driver transfers the relevant input data to the hardware accelerator, the hardware accelerator executes the VLIW instructions to evaluate the math function, and the output data (i.e., calculated result) is made available to the host software. In stimulus mode, the hardware accelerator can be viewed as a data-driven machine that receives input data (e.g., via DMA from the host computer 110 to the hardware simulator 130), executes the math evaluation, and obtains the corresponding result (for DMA to the host computer 110).

Accordingly, the disclosure of the present invention is intended to be illustrative, but not limiting, of the scope of the invention, which is set forth in the following claims.

What is claimed is:

1. A method for logic simulation of a chip design, the chip design divisible into a plurality of domains, the method comprising:
loading a state space of a first domain into a local memory of a simulation processor;
executing instructions on the simulation processor to simulate the logic of the first domain; and
storing a history of the state space of the first domain, the history comprising the state space of the first domain for different simulated times.

2. The method of claim 1 wherein:
the step of loading a state space of the first domain comprises loading the state space from a program memory accessible by the simulation processor;
the step of executing instructions on the simulation processor comprises:
loading the instructions from the program memory into the simulation processor, the simulation processor having n processor units; and
executing the instructions on the processor units to simulate the logic of the first domain; and
the step of storing the history of the state space comprises transferring the state spaces for different simulated times from the local memory to a memory external to the simulation processor.

3. The method of claim 2 wherein the step of storing the history of the state space comprises transferring the state spaces for different simulated times from the local memory to the program memory.

4. The method of claim 3 wherein the step of storing the history of the state space comprises transferring the state spaces for different simulated times from the local memory to sequential locations in the program memory.

5. The method of claim 2 wherein the step of storing the history of the state space comprises transferring the state spaces for different simulated times from the local memory to a storage memory that is separate from the program memory and accessible by the simulation processor.

6. The method of claim 2 wherein the step of storing the history of the state space comprises transferring the state spaces for different simulated times from the local memory to a main memory of a host computer.

7. The method of claim 6 wherein the state spaces for different simulated times are transferred from the local memory to the main memory by DMA while the simulation processor is idling.

8. The method of claim 2 wherein the step of storing the history of the state space comprises transferring the state spaces for different simulated times from the local memory to memory located on an extension card to the simulation processor.

9. The method of claim 2 wherein the step of storing the history of the state space comprises transferring the state spaces for simulated times requested by the user.

10. The method of claim 2 wherein the history of the state space comprises the state space for every simulated time step.

11. The method of claim 2 wherein the step of storing the history of the state space comprises storing the history of the state space in a compressed form.

12. The method of claim 1 wherein the simulation processor is a VLIW simulation processor.

13. A method for logic simulation of a chip design, the chip design divisible into a plurality of clock domains, the method comprising:
simulating the logic of a selected clock domain, wherein the step of simulating comprises:
loading a state space of the selected clock domain into a local memory of a simulation processor;
executing instructions on the simulation processor to simulate the logic of the selected clock domain; and
swapping out the state space of the selected clock domain from the local memory when a different clock domain is to be simulated; and
repeating the step of simulating the logic of a selected clock domain, wherein the clock domains are selected for simulation in an order based on a chronological order of the clock edges for the clock domains.

14. The method of claim 13 wherein:
the step of loading the state space of the selected clock domain comprises loading the state space from a program memory accessible by the simulation processor;
the step of executing instructions on the simulation processor comprises:
loading the instructions from the program memory into the simulation processor, the simulation processor having n processor units; and
executing the instructions on the processor units to simulate the logic of the selected clock domain; and
the step of swapping out the state space of the selected clock domain comprises transferring the state space from the local memory to the program memory.

15. The method of claim 14 wherein the chip design is divisible into a global clock domain and a plurality of local clock domains, and the step of simulating the logic of a selected clock domain comprises simulating the logic of a selected local clock domain and of the global clock domain.

16. The method of claim 15 wherein instructions and state spaces for the local clock domains are stored in program memory separate from instructions and state spaces for the global clock domain.

17. The method of claim 14 wherein every instance of loading a state space of the selected clock domain into the local memory and swapping out the state space of the selected clock domain from the local memory are initiated by a software driver for the simulation processor.

18. The method of claim 14 wherein the state space of the selected clock domain is not swapped out if the next clock domain to be simulated is the same clock domain.

19. The method of claim 14 wherein at least some instances of loading a state space of the selected clock domain into the local memory and swapping out the state space of the selected clock domain from the local memory are not initiated by a software driver for the simulation processor.

20. The method of claim 14 wherein the clock domains are selected for simulation in an order that exactly follows the chronological order of the clock edges for the clock domains.

21. The method of claim 14 wherein the clock domains are selected for simulation in an order that does not exactly follow the chronological order of the clock edges for the clock domains.

22. The method of claim 14 wherein the state spaces for more than one clock domain are stored in the local memory.

23. The method of claim 14 further comprising, for at least one selected clock domain, simulating the logic of the selected clock domain for multiple simulated time steps without swapping out the state space and saving the state spaces for at least one of the intermediate simulated time steps.

24. A logic simulation system comprising:
a simulation processor having multiple processor units coupled to a plurality of memory controllers; and
a program memory coupled to the simulation processor, the program memory logically organized into memory slices and having a plurality of program memory instances, each program memory instance controlled by a corresponding memory controller and logically representing one of the memory slices of the program memory, the program memory containing instructions for execution by the processor units and further containing data for use by the processor units.

25. The logic simulation system of claim 24 wherein each program memory instance includes one or more memory chips.

26. The logic simulation system of claim 24 wherein different addresses within the program memory can be simultaneously addressed by different memory controllers.

27. The logic simulation system of claim 24 wherein the processor units are logically organized into processor clusters.

28. The logic simulation system of claim 27 wherein each processor cluster corresponds to one of the memory controllers and the processor units in that processor cluster access the program memory via that memory controller.

29. The logic simulation system of claim 27 wherein at least one processor cluster includes N processor units, and the cluster-level instruction for that processor cluster includes N individual PE-level instructions, one for each processor unit.

30. The logic simulation system of claim 27 wherein at least one processor cluster includes N processor units, and the cluster-level instruction for that processor cluster is not divisible into N individual PE-level instructions.
